(19) United States
(12) Patent Application Publication
(10) Pub. No.: US 2015/0060430 A1
(43) Pub. Date: Mar. 5, 2015

(54) HEAT-RETAINING JACKET

(71) Applicant: MAKITA CORPORATION, Anjo-shi (JP)

(72) Inventors: Kazunori TSUGE, Anjo-shi (JP); Katsuhito FUJINAMI, Anjo-shi (JP)

(21) Appl. No.: 14/459,940

(22) Filed: Aug. 14, 2014

(30) Foreign Application Priority Data
Sep. 3, 2013 (JP) 2013-182074

(51) Int. Cl. A41D 13/005; A41D 1/02; H05B 3/00

(52) U.S. Cl. CPC A41D 13/0051; H05B 3/00; A41D 1/02
USPC 219/211

(57) ABSTRACT

A heating jacket of the present invention includes a jacket main body provided with a pocket, a heating element that is housed between a face cloth and a lining cloth of the jacket main body, and a battery that supplies power to the heating element. The jacket main body is provided with a power line through which the power of the battery can be supplied to the heating element. Holes are formed in the jacket main body for passing the power line 39 therethrough such that the battery can be positioned in the pocket or in the reverse side of the jacket main body.

This application claims priority to Japanese patent application serial number 2013-182074, the contents of which are incorporated herein by reference.

### BACKGROUND OF THE INVENTION

1. Field of the Invention

Embodiments of the present invention relate to a heat-retaining jacket having a jacket main body that comprises a face cloth and a lining cloth. It also has a pocket, an electric heating element that is housed between the face cloth and the lining, and a battery that supplies an electric power to the heating element.

2. Description of the Related Art

A heat-retaining jacket relating to the above is described in Japanese Examined Patent Publication No. H05-61361 as prior art.

As shown in FIG. 12, a heat-retaining jacket 100 comprises a face cloth 102 and a lining cloth 103. The heat-retaining jacket has a jacket main body 101 in which an inner pocket 104 is provided on the left side thereof. An electric heating element 105 is held and attached between the face cloth 102 and the lining cloth 103. The heating element 105 is electrically connected to a battery 108 via power lines 106, and a battery 108 is housed in the left inner pocket 104 of the jacket main body 101.

By constructing the heat-retaining jacket as described above, the heat element 105 is heated through electric power from the battery 108 and an inside of the jacket main body 101 is kept warm.

As described above, in the heat-retaining jacket 100, the battery 108 is housed in a left inner pocket 104 of the jacket main body 101. Accordingly, when a high-capacity and large-sized battery 108 is used in order to keep the heat-retaining jacket 100 warm for many hours, the heavy weight of the large-sized battery 108 pulls the left inner pocket 104 down in the vertical direction and the user may find the jacket main body 101 to be uncomfortable. Further, the appearance of the jacket main body 101 may be found unsightly.

Therefore, the large-sized battery 108 is hard to use in the heat-retaining jacket 100.

Thus, there is a need in the art such that the comfort and appearance of the heat-retaining jacket is maintained even when a large-sized battery is used in the heat-retaining jacket.

### SUMMARY OF THE INVENTION

According to a first aspect of the present invention, there is provided a heat-retaining jacket that comprises a jacket main body having a face cloth and a lining cloth. It also may have a pocket, an electric heating element that is housed between the face cloth and the lining cloth of the jacket main body, and a battery that supplies a power to the heating element. Further, the jacket main body is provided with a power line through which the power of the battery is supplied to the heating element. Further, a hole through which the power line is passed is formed in the jacket main body such that the battery can be positioned in the pocket or in a reverse side of the jacket main body.

In the first aspect, when a lightweight battery is used, the battery can be housed in the pocket. Further, the comfort and appearance of the jacket can be maintained despite the presence of the battery.

In a separate aspect, a large-sized battery is used and the battery can be positioned in the reverse side of the jacket main body. Accordingly, the large-sized battery can be attached, for example, to a belt of the trousers of a user. As a result, the weight of the large-sized battery is not applied to the jacket main body, and the comfort of the jacket main body can be maintained. Further, the appearance of the jacket main body can be maintained when a user wears it.

According to certain embodiments of the present invention, the hole is configured such that the power line can be passed through an inside of the pocket to the reverse side of the jacket main body.

In the above aspect, the power line that is led to the inside of the pocket can be further led to the reverse side of the jacket main body via the hole. As a result, the power line can be housed in the pocket or can be led to the reverse side of the jacket main body in an easy manner depending on the kind of batteries.

In certain embodiments, a first connector is provided at one end of the power line of the jacket main body and the first connector is detachably attached to a second connector that is provided at one end of a lead wire of an adapter for the battery. Further, the battery is configured to be attached to the adapter in a locked state and detached from the adapter.

In the above aspect, the power line of the jacket main body can be easily attached to and detached from the lead wire of the adapter of the battery for the electric power tool. Further, the power line can be easily passed through the hole of the jacket main body.

A hook may be provided in the adapter for holding the adapter and the battery to a user.

In the above aspect, when the adapter and the battery for the electric power tool are positioned in the reverse side of the jacket main body, the adapter can be easily attached, for example, to a belt of the trousers of the user.

In certain embodiments, a controller is provided in the jacket main body for constantly controlling the amount of heat in the heating element. Further, the controller is configured to extend an energization time as a voltage of the battery decreases in order to constantly control the amount of heat in the heating element.

Typically, the amount of heat in the heating element varies according to the charged amount of the battery in the electric power tool. Such a feature can be reduced in certain embodiments.

In certain embodiments, a means is provided in the jacket main body for stopping the energization of the heating element when the temperature of the heating element exceeds a predetermined value.

In the above aspect, an excessive temperature rise of the heating element can be prevented.

According to another aspect of certain embodiments, an LED is provided in the jacket main body for indicating an energization state of the heating element. Further, the LED is configured to be connected to a power supply via a constant current circuit.

Typically, as the voltage of the power supply varies, the brightness of the LED changes. In some of the embodiments, such an occurrence may be prevented.

According to the above, even when a high-capacity and heavyweight battery is used, the comfort and appearance of the jacket can be maintained.

### BRIEF DESCRIPTION OF THE DRAWINGS

FIG. 1A is an overall perspective view of a heat-retaining jacket of an embodiment 1 of the present invention.

FIG. 1B is a perspective view of the heat-retaining jacket in which sleeves are detached therefrom.

FIG. 1C is an enlarged perspective view showing an operation part positioned in a left chest area of an embodiment of a heat-retaining jacket.

FIG. 2 is a perspective view showing a reverse side of an embodiment of a heat-retaining jacket.

FIG. 3 is an enlarged view of a part III in FIG. 2.

FIG. 4 is a block diagram showing a wiring structure of an embodiment of a heat-retaining jacket of the embodiment 1.

FIG. 5 is a block diagram showing a controller of an embodiment of a heat-retaining jacket.

FIG. 6 is a schematic diagram showing how to control an amount of heat in an embodiment of a heat-retaining jacket.

FIG. 7 is a circuit diagram showing how to control an LED in an embodiment of a heat-retaining jacket.

FIG. 8A is a perspective view showing a small-sized battery for an electric power tool and an adaptor that are used in an embodiment of a heat-retaining jacket.

FIG. 8B is a perspective view showing a large-sized battery for an electric power tool battery and an adaptor that are used in an embodiment of a heat-retaining jacket.

FIG. 9A is a schematic longitudinal sectional view showing the way in which power lines are pulled around in an embodiment of a heat-retaining jacket.

FIG. 9B is a perspective view showing power lines that are pulled around in a pocket of an embodiment of a heat-retaining jacket.

FIG. 9C is a perspective view showing that an adaptor and a large-sized battery for an electric power tool are held in a belt of the trousers of a user.

FIG. 10A is a schematic longitudinal sectional view showing the way in which power lines are pulled around in an embodiment of a heat-retaining jacket.

FIG. 10B is a perspective view showing power lines that are pulled around in a pocket of an embodiment of a heat-retaining jacket.

FIG. 10C is a perspective view showing that an adaptor and a small-sized battery for an electric power tool are housed in the pocket of an embodiment of a heat-retaining jacket.

FIG. 11 is a schematic longitudinal sectional view showing the way in which power lines are pulled around in an embodiment of a heat-retaining jacket.

FIG. 12 is a typical perspective view of a heat-retaining jacket in the prior art.

### DETAILED DESCRIPTION OF THE INVENTION

Each of the additional features and teachings disclosed above and below may be utilized separately or in conjunction with other features and teachings to provide an improved heat-retaining jacket. Representative examples of the present teaching, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings.

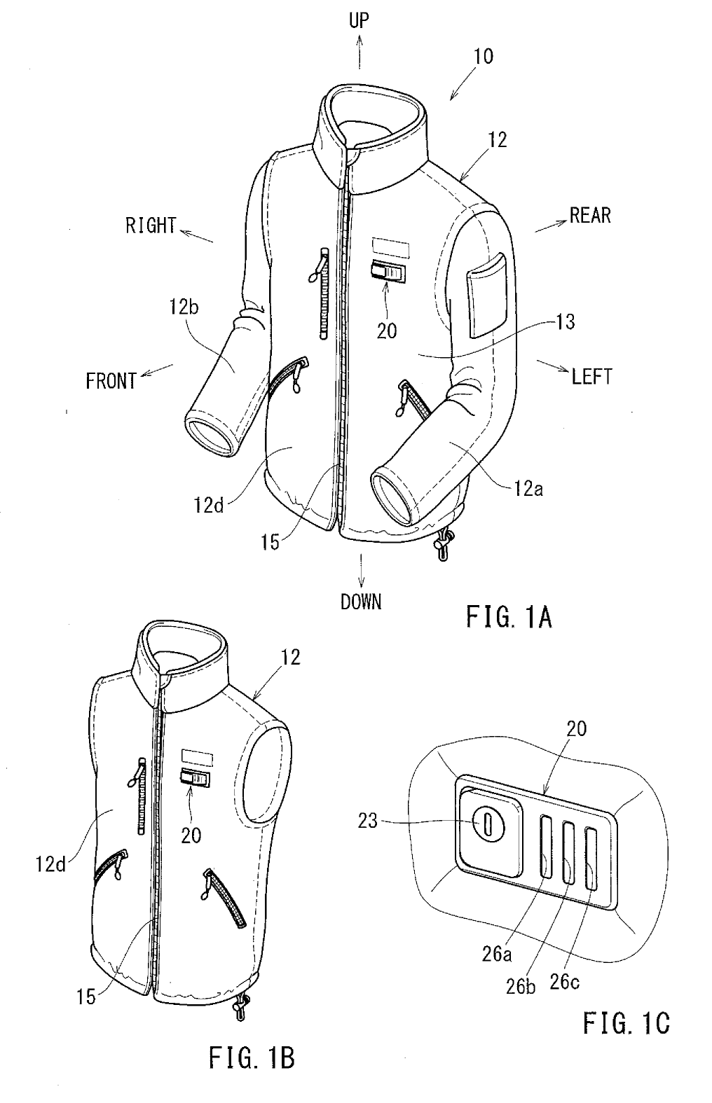

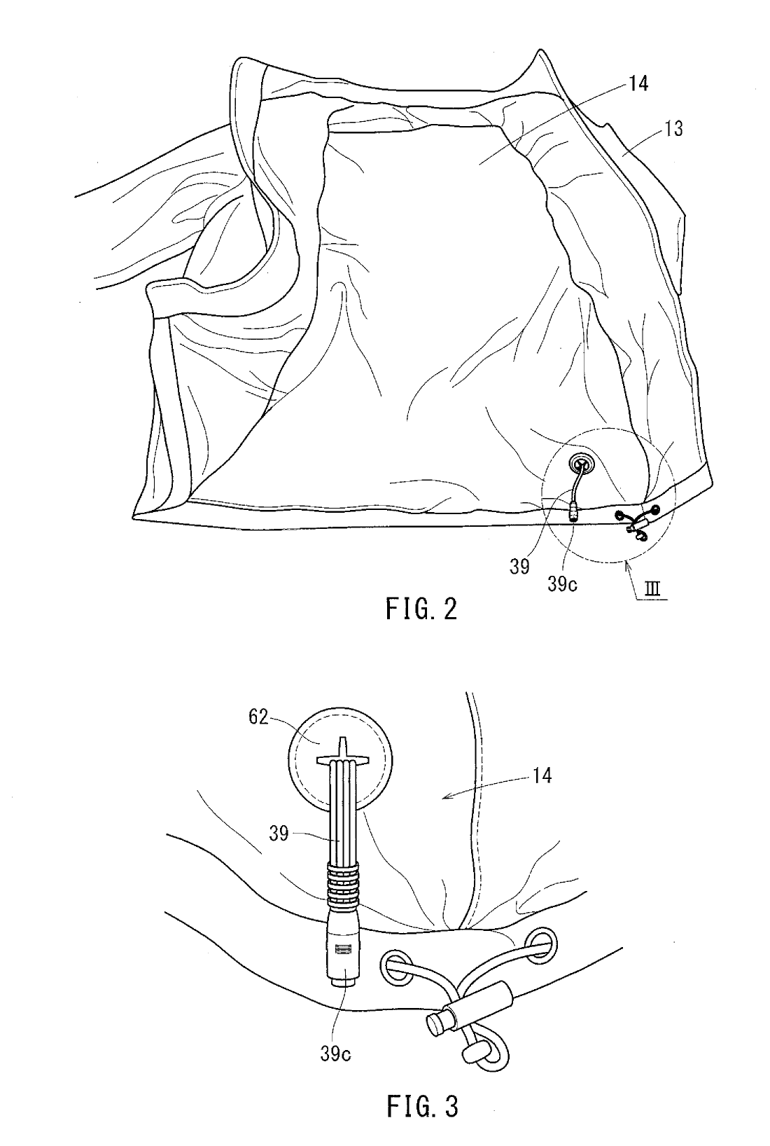

A heat-retaining jacket 10 according to an embodiment 1 of the present invention will be described below with reference to FIGS. 1 to 11. The heat-retaining jacket 10 is used in a cold district, and it is constructed such that a jacket main body 12 is kept warm by use of a battery for an electric power tool as a power source.

A front, rear, left, right, up, and down in the figures correspond to a front, rear, left, right, up, and down of the jacket main body 12, respectively.

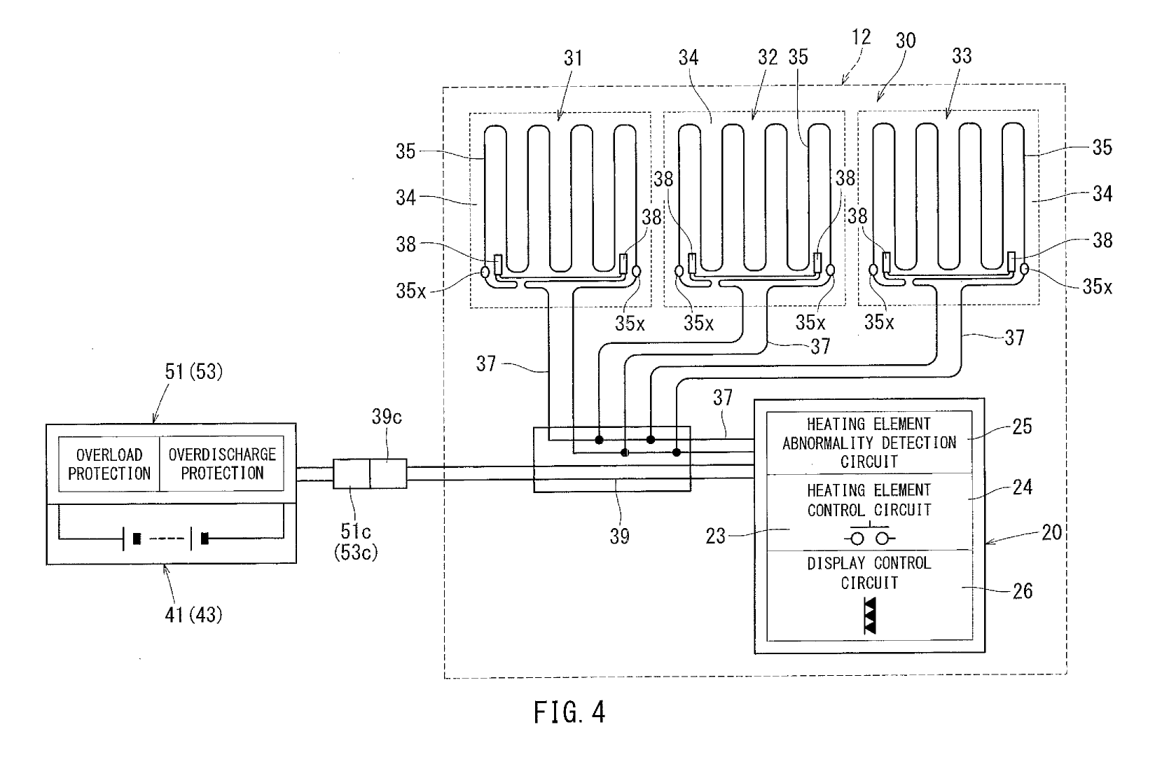

The heat-retaining jacket 10 includes the jacket main body 12 (refer to FIG. 1), heating elements 31, 32, and 33 (refer to FIG. 4) provided in the jacket main body 12, an electric circuit 30 (refer to FIG. 4) that controls the heating elements 31, 32, and 33, batteries 41 and 43 for an electric power tool that supply an electric power to the electric circuit 30, and adaptors 51 and 53.

As shown in FIG. 1A and FIG. 1B, the jacket main body 12 includes a body 12d that is configured to fasten in the front. The jacket main body 12 also preferably includes left and right sleeves 12a and 12b. The left sleeve 12a and the right sleeve 12b may be attached to and removed from the body 12d using a zipper (not shown).

Each of the body 12d, the left sleeve 12a, and the right sleeve 12b is made by sewing a waterproofing face cloth 13 and a thermal lining cloth 14 together.

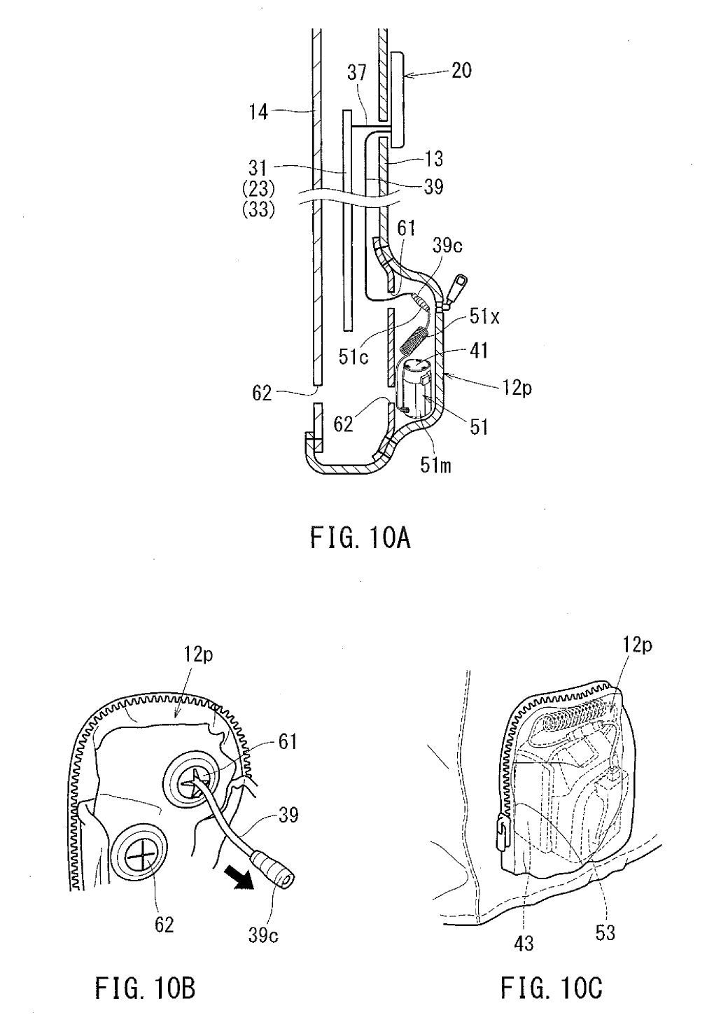

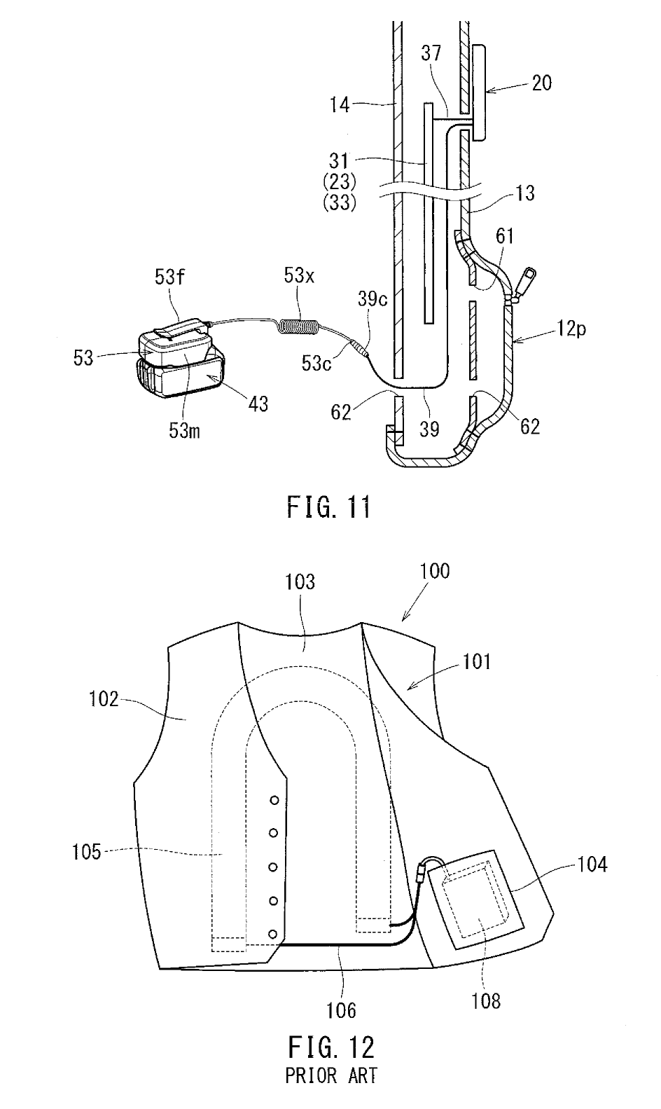

A back pocket 12p (refer to FIG. 10 etc.) configured to be able to house a small-sized battery etc. is provided on a lower left of a back face of the body 12d in the jacket main body 12. As shown in FIGS. 10A to 10C, a first hole 61 is provided in an inner upper portion of the back pocket 12p for leading both to an inside portion of the back pocket 12p and the heating elements housing portion positioned between the face cloth 13 and the lining cloth 14. Further, second holes 62 are provided in an inner lower portion of the back pocket 12p for leading both to the inside portion of the back pocket 12p and a reverse side of the jacket main body 12. The first hole 61 and the second holes 62 are configured to pass a power line 39 for the electric circuit 30 and a jacket side connector 39 therethrough.

A first heating element 31 is positioned in the body 12d of the jacket main body 12 between a left front side of the face cloth 13 and the lining cloth 14. A second heating element 32 is positioned between a right front side of the face cloth 13 and the lining cloth 14. A third heating element 33 is positioned between a back side of the face cloth 13 and the lining cloth 14.

A space for housing the first heating element 31, the second heating element 32, and the third heating element 33 between the face cloth 13 and the lining cloth 14 of the jacket main body 12 corresponds to a heating element housing portion.

As shown in FIG. 4, the first heating element 31, the second heating element 32, and the third heating element 33 may have the same structure. That is, each element may include a square cloth 34 and a carbon fiber resistor 35 that extends in a meandering manner on the surface of the cloth 34 from the left end to the right end thereof in the vertical direction. Heat-element-side electric wires 37 are connected to both ends of the carbon fiber 35. Further, in each of the first heating element 31, the second heating element 32, and the third heating element 33, thermostats 38 are provided in the vicinity of both sides of the connection parts 35x at which the carbon fiber 35 and the heat-element-side electric wires 37 are connected. The thermostats 38 stop energization of the first heating element 31, the second heating element 32, or the third heating element 33 when temperature of the connection parts 35x, which are apt to have a high temperature, exceeds a predetermined temperature. The thermostats 38 are connected to the carbon fiber 35 in series.

Each square cloth 34 is sewn both to the face cloth 13 and the lining cloth 14 of the jacket main body 12, and thus each of the first heating element 31, the second heating element 32, and the third heating element 33 is positioned on a predetermined position between the face cloth 13 and the lining cloth 14.

Each of the thermostats 38 corresponds to a means for stopping energization of the heating element.

As shown in FIG. 4, the electric circuit 30 includes a controller 20, the heat-element-side electric wires 37 that electrically connect the controller 20 to the first, second, and third heating elements 31, 32, and 33. It also includes power lines 39 that electrically connect the controller 20 to the batteries 41, 43 etc. for the electric power tool, and a jacket-side connector 39c provided in the power lines 39.

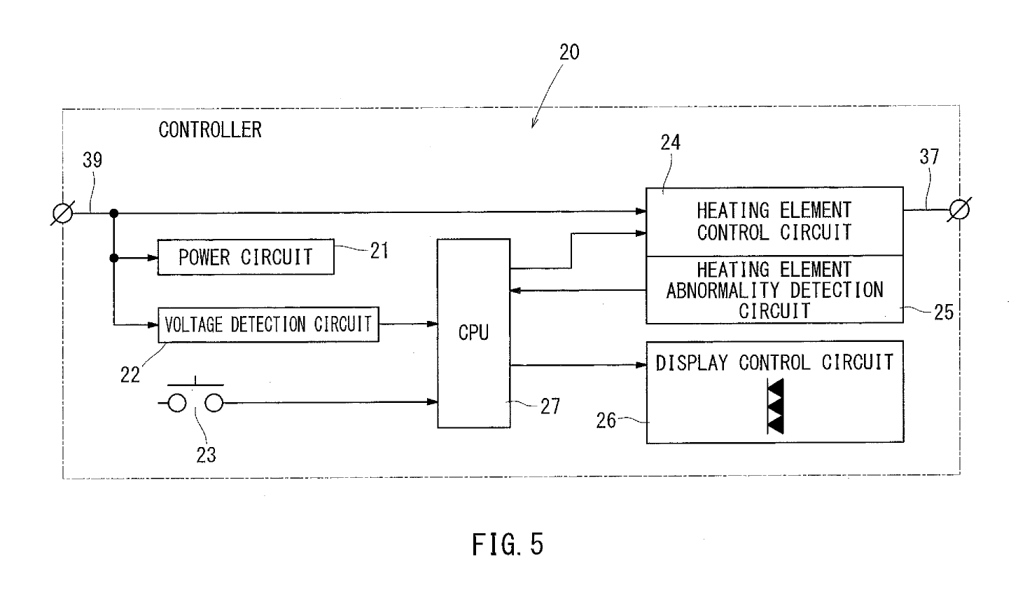

The controller 20 controls the first heating element 31, the second heating element 32, and the third heating element 33. As shown in FIG. 1A, the controller 20 is attached to a left chest area of the jacket main body 12. Further, as shown in FIG. 5, the controller 20 includes a power circuit 21, a voltage detection circuit 22, a switch 23, a heating element control circuit 24, a heating element abnormality detection circuit 25, a display control circuit 26, and a CPU 27.

The power circuit 21 converts a voltage of the battery 41 or 43 to a suitable voltage according to the specification of the heating elements 31, 32, and 33. The voltage detection circuit 22 detects a voltage of the battery 41 or 43 and inputs the detected voltage into the CPU 27.

The switch 23 switches on or off energization of the heating elements 31, 32, and 33. Further, the switch 23 controls an amount of heat in the heating elements 31, 32, and 33. As shown in FIG. 1C, the switch 23 is provided on a surface of the controller 20 that is positioned in the left chest area of the jacket main body 12. As shown in FIG. 5, a signal from the switch 23 is input to the CPU 27. The CPU 27 is configured such that energization of the heating elements 31, 32, and 33 is started when the switch 23 is pressed for a few seconds by a user, and the energization is stopped when the switch 23 is pressed again for a few seconds while the heating elements 31, 32, and 33 are energized.

Further, the CPU 27 is configured such that each time the switch 23 is pressed for a short time (less than 1 second) by the user, an amount of heat in the heating elements 31, 32, and 33 is switched in order from low, middle, and finally to a high temperature.

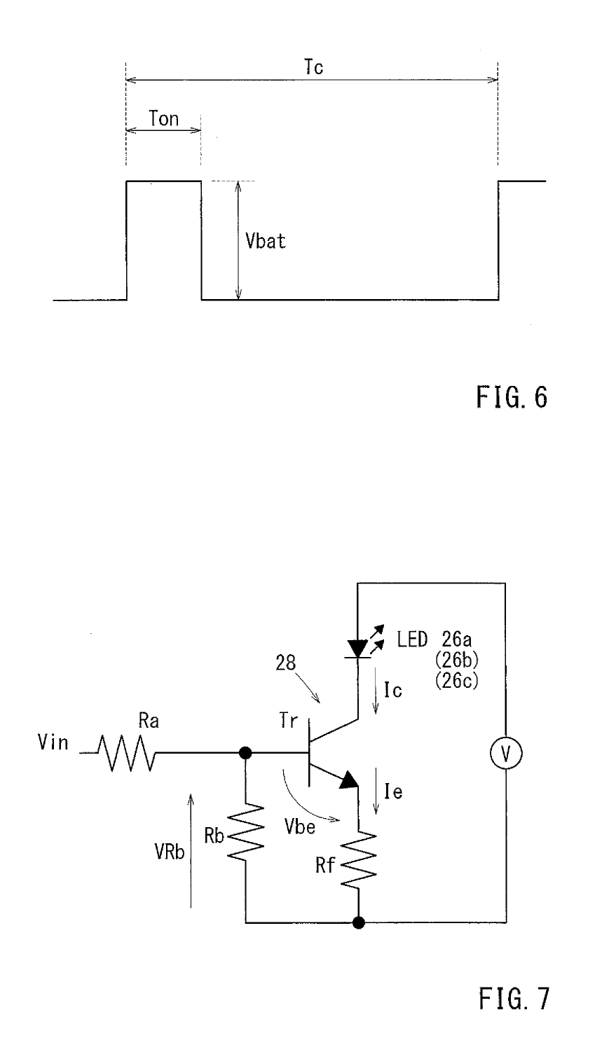

The heating element control circuit 24 controls an amount of heat in the heating elements 31, 32, and 33 based on a setting signal from the CPU 27, that is, a signal showing a low, middle, and high temperature. As shown in FIG. 6, the heating element control circuit 24 is configured to control the electric energy supplied to the heating elements 31, 32, and 33 by varying a ratio of a voltage pulse width Ton to a cycle Tc (for example, Tc=20 ms), i.e. a duty ratio. In this way, an amount of heat in the heating elements 31, 32, and 33 is controlled such that temperature of the heating elements 31, 32, and 33 becomes a low temperature H1, a middle temperature H2, or a high temperature H3.

Further, the heating element control circuit 24 is configured such that even when the capacity of the battery 41 or 43 decreases and the battery voltage decreases, an amount of heat in the heating elements 31, 32, and 33 is constantly controlled by increasing the duty ratio as the battery voltage decreases.

The heating element abnormality detection circuit 25 protects the first heating element 31, the second heating element 32, and the third heating element 33 against abnormal heating or overload (over current) caused by decreasing of the resistance of the first heating element 31, the second heating element 32, or the third heating element 33. The heating element abnormality detection circuit 25 monitors the resistance of the first heating element 31, the second heating element 32, and the third heating element 33. When detecting a resistance smaller than a predetermined value, the heating element abnormality detection circuit 35 outputs a heating element abnormal signal to the CPU 27. Receiving the heating element abnormal signal from the heating element abnormality detection circuit 35, the CPU 27 outputs an energization stop signal to the heating element control circuit 24.

The CPU 27 corresponds to a means for stopping energization of the heating elements.

The display control circuit 26 shows an energization state or an amount of heat of the heating elements 31, 32, and 33. The display control circuit 26 includes three LEDs 26a, 26b, and 26c, and three constant current circuits 28 each of which lights the LEDs 26a, 26b, and 26c, respectively. As shown in FIG. 1C, the three LEDs 26a, 26b, and 26c are positioned in the left chest area of the jacket main body 12 alongside of the switch 23. When an amount of heat in the heating elements 31, 32, and 33 is switched to the middle temperature H2, two LEDs 26a and 26b are turned on. When an amount of heat in the heating elements 31, 32, and 33 is switched to the high temperature H3, three LEDs 26a, 26b, and 26c are turned on. When an energization of the heating elements 31, 32, and 33 is stopped, all three of the LEDs are turned off.

As shown in FIG. 7, each of the LEDs 26a, 26b and 26e is connected to a collector of a transistor Tr in the constant current circuit 28. In the constant current circuit 28, the sum of a voltage between a base and an emitter of the Tr and a product of an emitter current Ie by a resistance Rf is configured to be equal to a base voltage VRb. Accordingly, even when a voltage applied to the LED 26a, 26b, or 26c varies, a current flowing the LED 26a, 26b, or 26c is not changed. Owing to this, even when the voltage applied to the LED 26a, 26b, or 26c varies, the brightness of the LEDs 26a, 26b, or 26c is not changed and thus the LEDs are maintained in an easy-to-see condition.

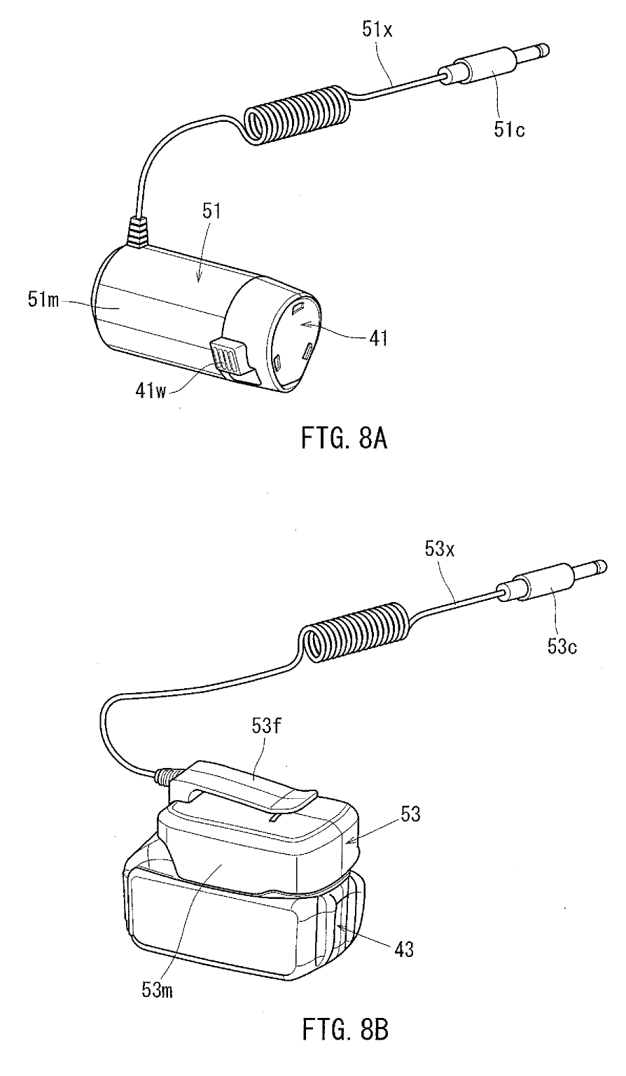

FIG. 8A shows a small-sized battery 41 for the electric power tool (hereinafter, termed small-sized battery 41) and an adapter 51 that connects the small-sized battery 41 to the electric circuit 30 of the jacket main body 12.

The small-sized battery 41 houses a plurality of secondary batteries (not shown) in a housing that is formed in an approximately tubular shape. The adapter 51 includes an adapter main body 51m that houses the small-sized battery 41 and forms in an approximately tubular shape, a lead wire 51x provided in the adapter main body 51m, and an adapter-side connector 51c provided at a tip end of the lead wire 51x. The small-sized battery 41 is configured to be electrically connected to the adapter main body 51m by being inserted into the adapter main body 51m. Further, a lock mechanism in which the small-sized battery 41 is held in an electrically connected state to the adapter 51m is provided between the small-sized battery 41 and the adapter main body 51m. Further, a locked state of the small-sized battery 41 and the adapter main body 51m can be released by pressing a lock release lever 41w provided in the small-sized battery 41.

The adapter-side connector 51c of the adapter 51 is configured to be connected to the jacket-side connector 39c in the electric circuit 30 (electric wire 39) of the jacket main body 12. When the connector 51c is connected to the connector 39c, the small-sized battery 41 is electrically connected to the electric circuit 30 of the jacket main body 12.

FIG. 8B shows a large-sized battery 43 for the electric power tool (hereinafter, termed large-sized battery 43) and an adapter 53 that connects the large-sized battery 43 to the electric circuit 30 of the jacket main body 12.

The large-sized battery 43 houses a plurality of secondary batteries (not shown) in a housing that is formed in an approximately tubular shape. The adapter 53 includes an adapter main body 53m that can be hooked to a belt etc. by a hook 53f and forms a square lid shape, a lead wire 53x provided in the adapter main body 53m, and an adapter-side connector 53c provided at a tip end of the lead wire 53x.

The adapter main body 53m is configured to be electrically connected to the large-sized battery 43 by sliding engagement with a pair of slide rails (not shown) that are formed on the surface of the large-sized battery 43. Further, a lock mechanism in which the large-sized battery 43 is held in an electrically connected state to the adapter 53m is provided between the large-sized battery 43 and the adapter main body 53m. Further, a locked state of the large-sized battery 43 and the adapter main body 53m can be released by pressing a lock release lever provided in the large-sized battery 43.

The adapter-side connector 53c of the adapter 53 is configured to be connected to the jacket-side connector 39c in the electric circuit 30 (electric wire 39) of the jacket main body 12.

As shown in FIG. 4, in each of the adapters 51 and 53, there is provided a overload protection circuit to cut off the current when a load current of the battery 41 or 43 for the electric power tool exceeds a predetermined value. Further, in each of the adapters 51 and 53, there is provided an overdischarge protection circuit to cut off the current when a voltage of the battery 41 or 43 for the electric power tool decreases below a predetermined value.

The following explains the way in which the heat-retaining jacket 10 is handled when the large-sized battery 43 and the adapter 43 are used.

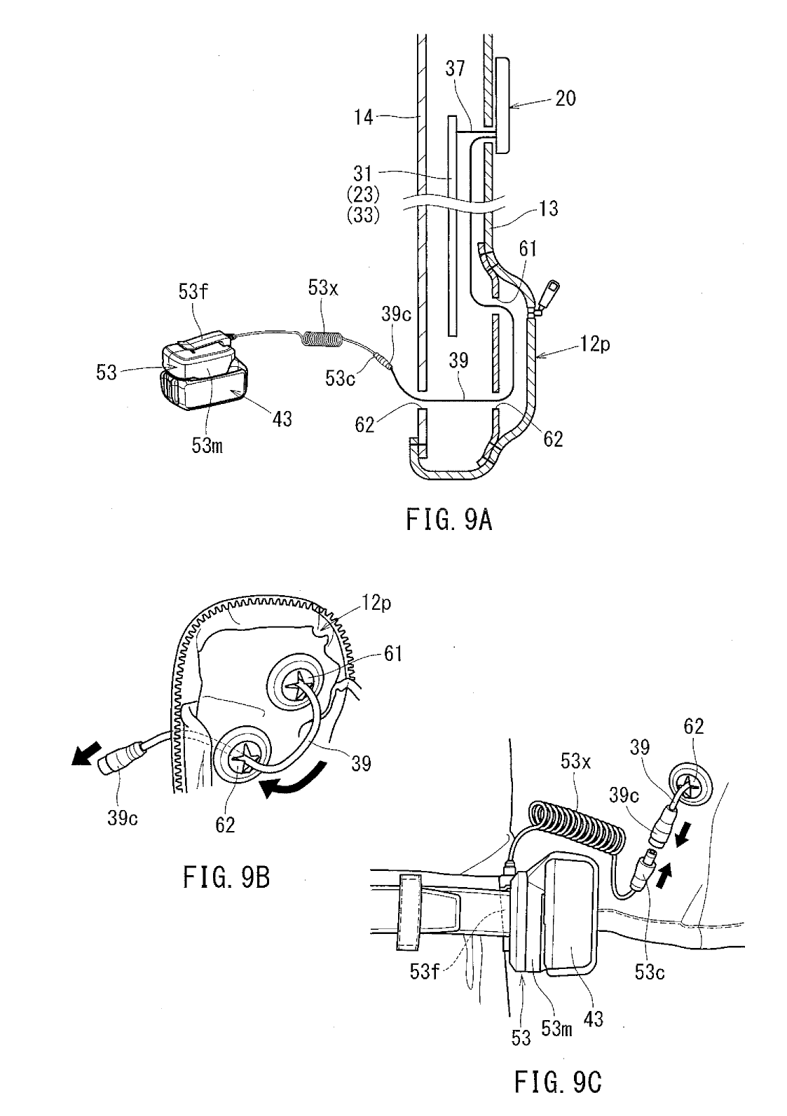

As shown in FIGS. 9A and 9B, when the large-sized battery 43 and the adapter 53 are used, the lead wire 39 of the electric circuit 30 of the jacket main body 12 and the jacket-side connector 39c are pulled into the pocket through the first hole 61 in the back pocket 12p. Next, the lead wire 39 and the jacket-side connector 39e are passed through the back pocket 12p and pulled to the reverse side of the jacket main body 12 through the second holes 62. Then, as shown in FIG. 9C, the hook 53f of the adapter main body 53m to which the large-sized battery 43 is connected is hooked to a belt of the trousers of a user. Next, the adapter-side connector 53c of the lead wire 53x of the adapter 53 is connected to the jacket-side connector 39c. In this way, an electrical connection of the large-sized battery 43 to the adapter 53 and the jacket main body 12 is completed.

When the switch 23 of the controller 20 positioned on the left chest area of the jacket main body 12 is pressed for a few seconds, the heating elements 31, 32, and 33 are energized. Further, when the switch 23 is pressed again for a short time, an amount of heat in the heating elements 31, 32, and 33 can be switched to the low temperature H1, the middle temperature H2, or the high temperature H3.

Next, the following explains the way in which the heat-retaining jacket 10 is handled when small-sized battery 41 and the adapter 51 are used.

As shown in FIGS. 10A and 10B, when the small-sized battery 41 and the adapter 51 are used, the lead wire 39 of the electric circuit 30 of the jacket main body 12 and the jacket-side connector 39c are pulled into the pocket through the first hole 61 in the back pocket 12p. Then, as shown in FIG. 10A, the jacket-side connector 39c is connected to the adapter-side connector 51c of the lead wire 51x of the adapter main body 51 m to which the small-sized battery 41 is connected. In this way, an electrical connection of the small-sized battery 41 to the adapter 51 and the jacket main body 12 is completed.

As shown in FIG. 10C, when a box-shaped battery 43 and the adapter 53 are small and lightweight ones, it may be possible to house them in the back pocket 12p.

Alternatively, as shown in FIG. 11, when the large-sized battery 43 and the adapter 53 are used, the jacket-side connector 39c and the lead wire 39 of the electric circuit 30 of the jacket main body 12 can be pulled to the reverse side of the jacket main body 12 directly through the second hole 62.

With regards to the heat-retaining jacket 10 of certain embodiments, the battery 41 for the electric power tool can be housed in the back pocket 12p by passing the power line 39 by which the electric power of the battery 41 is supplied to the heating elements 31, 32, and 33 through the first hole 61. That is, when the small and lightweight battery 41 for the electric power tool is used, the battery 41 can be housed in the pocket. Further, when the small-sized battery is housed in the back pocket 12p, the comfort and appearance of the heat-retaining jacket can be maintained when worn.

Further, by passing the power line 39 through the second hole 62, the large-sized battery for the electric power tool can be positioned on the reverse side of the jacket main body 12. Due to this, when the large-sized battery is used, the battery 43 can be attached, for example, to the belt of the trousers of a user. Accordingly, the weight of the large-sized battery is not applied to the jacket main body 12 and the comfort and appearance of the jacket main body 12 can be maintained.

Further, the second holes are configured to lead to both the reverse side of the jacket main body 12 and the inside of the back pocket 12p. Thus, the power line 39 that is led to the inside of the back pocket 12p through the first hole 61 can be led to the reverse side of the jacket main body 12 through the second holes 62. In this way, depending on the kind of batteries 41 or 43, the power line 39 can be housed in the back pocket 12p or can be led to the reverse side of the jacket main body 12 in an easy manner.

Further, the jacket-side connector 39c is provided at the end portion of the power line 39 of the jacket main body 12. Due to this, the adapter-side connector 51c or 53c provided at the end portion of the lead wire 51x or 53x of the adapter 51 or 53 is configured to be connected to the jacket-side connector 39c.

Because of this, the power line 39 of the jacket main body 12 can be easily connected to and disconnected from the lead wire 51x or 53x of the adapter 51 or 53 of the battery 41 or 43. Further, the power line 39 can be easily passed through the first hole 61 or the second holes 62 of the jacket main body 12.

Further, the hook 53f is provided in the adapter 53 for retaining the adapter 53 and the battery 43 for the electric power tool to a user. Because of this, when the adapter 53 and the battery 43 for the electric power tool are positioned on the reverse side of the jacket main body 12, the adapter 53 can be easily attached, for example, to the belt of the trousers of the user.

Further, the controller 20 is provided in the jacket main body 12 for constantly controlling the amount of heat in the heating elements 31, 32, and 33. In more detail, the controller 20 extends an energization time as a voltage of the battery 41 or 43 decreases, and thus an amount of heat in the heating elements 31, 32, and 33 can be constantly controlled. As a result, the incidence with which an amount of heat in the heating elements 31, 32, and 33 varies according to a charged amount of the battery 41 or 43 for the electric power tool can be decreased.

Further, a means for stopping energization of the heating elements 31, 32, and 33 is provided in each of the heating element 31, 32, and 33 when temperature of the heating element 31, 32, and/or 33 exceeds a predetermined value. As a result, an excessive temperature rise of the heating elements 31, 32, and/or 33 can be prevented.

Further, the LEDs 26a, 26b, and 26c are provided in the jacket main body 12 for indicating an energization state of the heating elements 31, 32, and 33. The LEDs 26a, 26b, and 26c are configured to be connected to the power supply via the constant current circuits 28, respectively. As a result, the incidence in which the brightness of the LEDs 26a, 26b, and 26c is changed according to fluctuation in voltage of a power supply can be decreased.

The present invention is not limited to the above-described embodiments and can be modified without departing from the scope of the present invention. In some of the above embodiments, the switch 23 and the display control circuit 26 of the controller 20 are positioned in the chest area of the jacket main body 12. However, the position of the switch 23 and the display control circuit 26 can be modified as needed.

Further, the heating elements 31, 32, and 33 may be provided in the three positions, i.e. the left front side, the back side, and the right front side of the jacket main body 12. However, they can be provided in two positions, i.e. the left front side and the right front side of the jacket main body 12. Alternatively, it is also possible to provide them around a neck of the jacket main body 12.

Further, in some of the present embodiments, the thermostats 38 are provided in the vicinity of the connection parts 35x at which the carbon fiber 35 of the heating elements 31, 32, and 33 are connected to the heat-element-side electric wires 37, and energization of the heating elements 31, 32, and 33 is stopped when temperature of the thermostats 38 exceeds a predetermined value, as an example. However, instead of using the thermostat, it is possible to provide a temperature sensor such as a thermistor and to input a signal of the thermistor etc. to the CPU 27 in the controller 20.

We claim:

1. A heat-retaining jacket, comprising a jacket main body having a face cloth, a lining cloth and a pocket, an electric heating element that is housed between the face cloth and the lining cloth of the jacket main body, and a battery that supplies power to the heating element, wherein:
the jacket main body is provided with a power line through which the power of the battery is supplied to the heating element; and
a hole through which the power line is passed is formed in the jacket main body such that the battery can be positioned in the pocket or in a reverse side of the jacket main body.

2. The heat-retaining jacket according to claim 1, wherein the hole is configured such that the power line can be passed through an inside of the pocket to the reverse side of the jacket main body.

3. The heat-retaining jacket according to claim 1, wherein:
a first connector is provided at one end of the power line of the jacket main body, the first connector is detachably attached to a second connector that is provided at one end of a lead wire of an adapter for the battery; and
the battery is configured to be attached to the adapter in a locked state and detached from the adapter.

4. The heat-retaining jacket according to claim 3, wherein a hook is provided in the adapter for holding the adapter and the battery to a user.

5. The heat-retaining jacket according to claim 1, wherein:
a controller is provided in the jacket main body for constantly controlling an amount of heat in the heating element; and
the controller is configured to extend an energization time as a voltage of the battery decreases in order to constantly control the amount of heat in the heating element.

6. The heat-retaining jacket according to claim 1, wherein a means is provided in the jacket main body for stopping energization of the heating element when temperature of the heating element exceeds a predetermined value.

7. The heat-retaining jacket according to claim 1, wherein:
an LED is provided in the jacket main body for indicating an energization state of the heating element; and
the LED is configured to be connected to a power supply via a constant current circuit.

8. The heat-retaining jacket according to claim 7, wherein a plurality of LEDs are provided to indicate separate temperature levels in the heating element.
